(19) United States
(12) Patent Application Publication
(10) Pub. No.: US 2004/0009779 A1
(43) Pub. Date: Jan. 15, 2004

(54) Management of SMS memory full condition in CDMA systems

(76) Inventors: Hai Qu, San Diego, CA (US); Nobuyuki Uchida, San Diego, CA (US)

Correspondence Address: Qualcomm Incorporated, Patents Department, 5775 Morehouse Drive, San Diego, CA, 92121-1714, US

(21) Appl. No.: 10/192,218

(22) Filed: Jul. 9, 2002

(51) Int. Cl. H04Q 7/20; H04M 1/00; H04B 1/38

(52) U.S. Cl. 455/466; 455/560; 455/445

(57) ABSTRACT

Techniques for managing memory full condition at a mobile station for SMS messages. At the mobile station, a short message is initially received and, if resources are not available to process this message, a reply message with an indication of resource shortage is sent. A notification message is thereafter sent after the resources become available. The resources may relate to the memory used to store short messages. In this case, the reply message is sent if the memory is full and the notification message is sent after the memory becomes available. The notification message can be resent periodically and/or at designated times (e.g., at power up) until it is successfully received, which may be indicated by an acknowledgment for the notification message. A flag may be maintained in a non-volatile memory to indicate whether or not the notification message needs to be resent.

### BACKGROUND

1. Field

The present invention relates generally to wireless messaging communication, and more specifically to techniques for managing the condition whereby the memory used for SMS messages in a mobile station is full.

2. Background

Short Message Service (SMS) is a service that supports the exchange of SMS or short messages between mobile stations and a wireless communication system. These short messages may be user-specific messages intended for specific recipient mobile stations or broadcast messages intended for all mobile stations.

SMS may be implemented by various types of wireless communication networks, two of which are code division multiple access (CDMA) networks and time division multiple access (TDMA) networks. Each network typically further implement a particular mobile networking protocol that allows for roaming and advanced services, with ANSI-41 being commonly used for CDMA networks (except for W-CDMA) and GSM Mobile Application Part (GSM-MAP) being used for GSM and W-CDMA networks. Since SMS is network technology dependent (ANSI-41 or MAP), CDMA and GSM networks that implement different network technologies support different implementations of SMS. Each SMS implementation has different capabilities and utilizes different message types and formats for sending short messages.

In the SMS implementation for ANSI-41 based networks, which is referred to herein as CDMA-SMS, one message type is defined for sending SMS messages from the mobile stations to the network and another message type is defined for sending SMS messages from the network to the mobile stations. Other message types are also defined for cancellation and acknowledgment of SMS messages that have been sent. The sender of an SMS message may request an acknowledgement from the receiver for the sent message by including a Bearer Reply Option parameter in the sent message. These various message types are collectively used to provide efficient and reliable delivery of SMS messages between the mobile stations and the network.

At the mobile stations, SMS messages received from the network are normally processed and then stored in a memory. For CDMA-SMS, if a new SMS message is received by a mobile station and the memory used for SMS messages is full, then the mobile station would send an acknowledgment message back to the network if the Bearer Reply Option parameter is included in the received SMS message. The acknowledgment message would typically include an error code of “Destination Resource Shortage” to inform the network of the memory full condition at the mobile station.

Currently, there is no way for the network to know when the mobile station's memory becomes available. Thus, upon receiving the acknowledgment message with the “Destination Resource Shortage” error code, the network can either abandon the transmission of the SMS message or wait for some time to elapse before resending the message. Since this wait or timeout period can potentially be long, the message transmission delay is correspondingly long and the performance for SMS can be poor. Moreover, each retransmission of the SMS message would result in the same error acknowledgment if the memory at the mobile station is still full. These unsuccessful retransmission attempts degrade network performance and further cause unnecessary traffic.

There is therefore a need in the art for techniques to manage the condition whereby the memory used for SMS messages in a mobile station is full, such that improved performance can be achieved for both the mobile station and the network.

### SUMMARY

Techniques are provided herein to manage the memory full condition at a mobile station. In an aspect, a notification message is provided and may be used to inform the network when the mobile station's memory becomes available. In another aspect, techniques are provided for the mobile station to keep track of whether or not the memory available notification needs to be sent/resent, and for the message center to keep track of memory availability at the mobile station. These techniques can improve SMS performance for both the network and the mobile user.

In one embodiment, a method is provided for facilitating the transmission of short messages in a wireless (e.g., cdma2000) communication network. In accordance with the method, which may be performed at a mobile station, a short message is initially received. A reply message with an indication of resource shortage (e.g., an SMS Acknowledge Message with a proper error code) is then sent if resources are not available to process the received short message. A notification message (e.g., an SMS Memory Available Notification Message) is thereafter sent when the resources become available.

The resources may relate to the memory used to store short messages. In this case, the reply message is sent if the memory is full and the notification message is sent when the memory becomes available. The notification message can be resent periodically and/or at designated times (e.g., at power up) until it is successfully received, which may be indicated by an acknowledgment for the notification message. A flag may be maintained (e.g., in a non-volatile memory) and used to indicate whether or not the notification message needs to be sent/resent.

In another embodiment, a method is provided for sending short messages in the wireless communication network. In accordance with the method, which may be performed at a message center, a message with an indication of resource shortage is initially received from a particular mobile station. Transmission of short messages to this mobile station is thereafter halted. A notification message that the resources have become available is subsequently received from the mobile station. Thereafter, transmission of short messages to the mobile station is enabled. Again, the resources may relate to the memory used to store short messages at the mobile station. An indicator may be maintained to keep track of resource availability at the mobile station, and this indicator may be checked prior to sending any short messages to the mobile station.

Various aspects and embodiments of the invention are described in further detail below. The invention further provides methods, program codes, digital signal processors, mobile stations, base stations, systems, and other apparatuses and elements that implement various aspects, embodiments, and features of the invention, as described in further detail below.

### BRIEF DESCRIPTION OF THE DRAWINGS

The features, nature, and advantages of the present invention will become more apparent from the detailed description set forth below when taken in conjunction with the drawings in which like reference characters identify correspondingly throughout and wherein:

FIG. 1 is a diagram of a wireless communication network that supports SMS;

FIG. 2 is a block diagram of a message center and a mobile station;

FIGS. 3A and 3B are diagrams of an SMS Memory Available Notification Message and an SMS Acknowledge Message, respectively;

FIGS. 4A and 4B are diagrams illustrating the signal flows for sending an SMS message from the message center to a recipient mobile station with two different error codes;

FIG. 5 shows the states for the SMS memory at the mobile station;

FIG. 6 is a flow diagram of a process performed by the mobile station to process a mobile-terminated SMS message;

FIG. 7 is a flow diagram of a process performed by the mobile station to monitor its memory and to send the memory available notification to the network;

FIG. 8 is a flow diagram of a process performed by the message center to send an SMS message to the mobile station; and

FIG. 9 is a flow diagram of a process performed by the message center to maintain the Memory Available indicators for the mobile stations.

### DETAILED DESCRIPTION

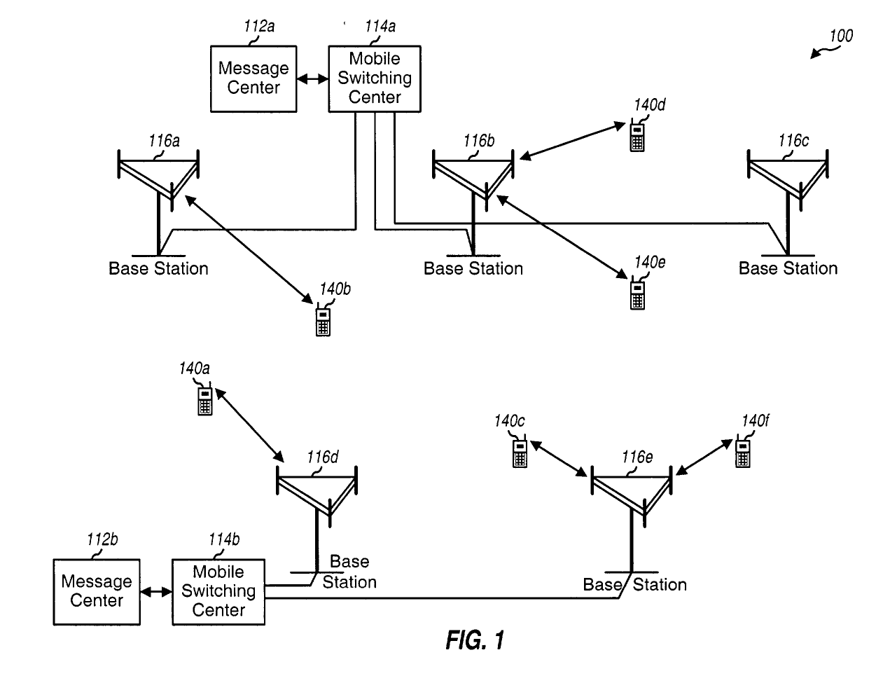

FIG. 1 is a diagram of a wireless communication network 100 that supports Short Message Service (SMS). Network 100 includes a number of message centers (MCs) 112, mobile switching centers (MSCs) 114, and base stations 116. The message centers are responsible for storing, relaying, and forwarding short messages for mobile stations 140 within the network. The MSCs perform switching functions (i.e., routing of messages and data) for the mobile stations within their coverage area. The message centers may be implemented separate from or integrated with the MSCs. Each mobile station is served by one MSC at any given moment, and this MSC is referred to as the mobile station's serving MSC. The base stations are fixed stations used for communicating with the mobile stations.

In the embodiment shown in FIG. 1, each message center communicates with a corresponding MSC to support SMS. Each MSC further couples to a number of base stations and controls the communication for the mobile stations under the coverage of these base stations. Each base station communicates with the mobile stations under its coverage area to support SMS and other services (e.g., voice, packet data, and so on). Each mobile station may communicate with one or more base stations at any given moment, depending on whether or not it is active and whether or not soft handoff is supported.

Network 100 may be a CDMA network, a TDMA network, or some other type of network. A CDMA network may be designed to implement one or more standards such as cdma2000, W-CDMA, IS-95, and so on. A TDMA network may also be designed to implement one or more standards such as Global System for Mobile Communications (GSM). A network may also employ and support a combination of different technologies. For example, a GSM1x network is a GSM-MAP network that is overlaid over a CDMA air interface, and GSM SMS messages are sent via the CDMA air interface in the form of CDMA SMS messages.

The techniques described herein for managing the memory full condition may be used in various networks. For clarity, various aspects and embodiments are specifically described for an ANSI-41 based network. The SMS implementation for ANSI-41 based networks is described in detail in TIA/EIA-637-B, entitled “Short Message Service for Wideband Spread Spectrum Systems.” ANSI-41 is described in ANSI/TIA/EIA-41-D, entitled “Cellular Radio-Telecommunications Intersystem Operations.” Both of these standard documents are publicly available and incorporated herein by reference.

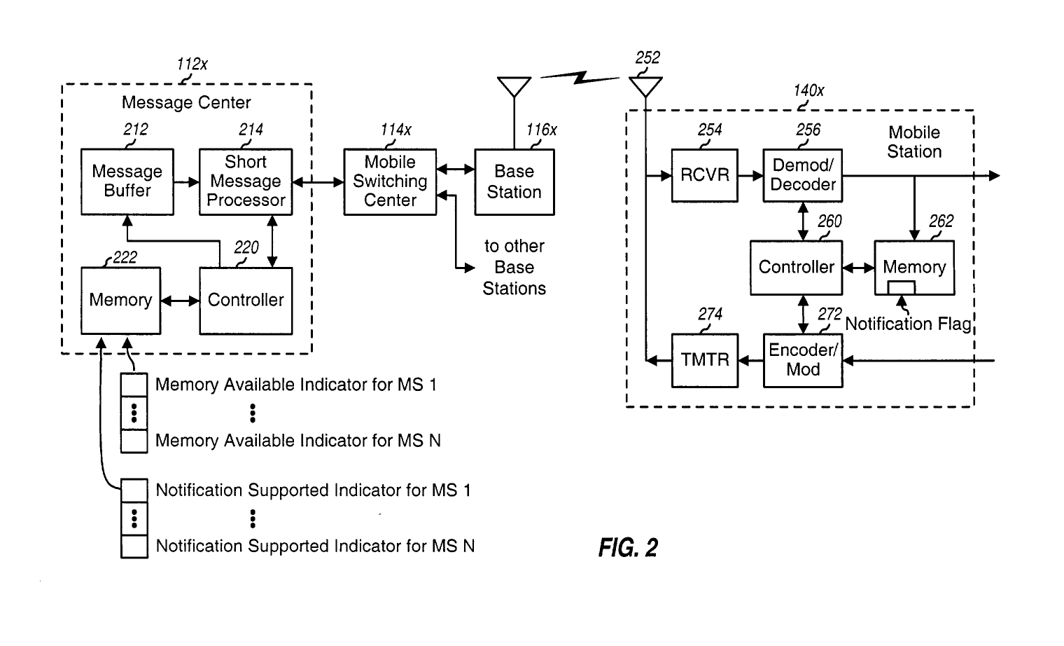

FIG. 2 is a block diagram of an embodiment of a message center 112x and a mobile station 140x. Within message center 112x, data for SMS messages to be sent to the mobile stations is initially stored in a message buffer 212. The data is thereafter retrieved from the buffer as needed and provided to a short message processor 214, which forms SMS messages of the proper type and in the proper format. The SMS messages are then provided to the associated MSC 114x, which further forwards these messages to the proper base stations 116 within its control. Each base station processes the SMS messages to be sent to the mobile stations within its coverage area and includes the processed messages in a modulated signal that is transmitted to the mobile stations.

Within message center 112x, a controller 220 directs the flow of data through the message center and further controls the processing to generate short messages. A memory unit 222 provides storage for program codes and data used by controller 220.

FIG. 2 also shows an embodiment of mobile station 140x. On the receive path, the modulated signal transmitted from the mobile station's serving base station is received by an antenna 252 and provided to a receiver unit (RCVR) 254. Receiver unit 254 conditions (e.g., filters, amplifies, and downconverts) the received signal and further digitizes the conditioned signal to provide samples. A demodulator (Demod)/decoder 256 then demodulates the samples (e.g., based on cdma2000 physical layer processing) and further decodes the demodulated data to provide decoded data, which includes the SMS messages sent in the modulated signal. The data for the user-specific and broadcast SMS messages sent to this mobile station is provided as output data and may further be stored in a memory 262.

On the transmit path, data and messages to be sent by the mobile station are provided to an encoder/modulator (Mod) 272, which encodes and modulates the data/messages. The modulated data is then conditioned by a transmitter unit (TMTR) 274 to provide a modulated signal suitable for transmission back to the base station.

A controller 260 directs the operation of the units within mobile station 140x. For example, controller 260 may direct the processing of received SMS messages and the transmission of SMS messages for acknowledgment, data, and so on. A memory unit 262 provides storage for program codes and data used by controller 260 (e.g., data for SMS messages).

FIG. 2 shows a specific embodiment of message center 112x and mobile station 140x. Other embodiments may also be contemplated and are within the scope of the invention. In message center 112x, short message processor 214 may be implemented within controller 220 or within some other processing unit.

As noted above, a memory (e.g., memory unit 262) is often used at the mobile station to store SMS messages received from the network. This memory may also be used to store data for other functions. In any case, the amount of memory allocated to and available for use for SMS (i.e., the SMS memory) is typically limited. The SMS memory would become full if the SMS messages to be stored in the memory exceed capacity.

For CDMA-SMS, if a new SMS message is received by the mobile station and the SMS memory is full, then the mobile station can indicate this condition to the network by sending an SMS Acknowledge Message with an error code of “Destination Resource Shortage”, if the Bearer Reply Option parameter is included in the received SMS message. The network can thus be informed if the SMS memory at the mobile station is full. However, the network currently has no way of knowing when the SMS memory becomes available again. Thus, upon receiving this acknowledgment message, the network can either abandon the transmission of the SMS message or wait for some amount of time to elapse before resending the message. This wait or timeout period can potentially be long. Moreover, there is no assurance that any retransmission attempt will be successful. Thus, SMS performance may be poor and network resources may be unnecessarily wasted.

In an aspect, techniques are provided to inform the network when the mobile station's SMS memory becomes available. The mobile station may send this information via a newly defined message, as described below. With this information, the network can resend the SMS message to the mobile station more quickly, without having to wait for the long timeout period to expire. Moreover, by resending the SMS message only when the SMS memory is available, the network can avoid unnecessary and unsuccessful retransmission attempts when the SMS memory is still full.

The SMS implementation in CDMA includes a number of layers for the SMS protocol stack. Of these layers, the SMS Transport Layer is the layer responsible for the delivery of SMS messages between the message center and the mobile stations. In particular, SMS messages are initially generated at the SMS Teleservice Layer. Teleservice Layer messages are provided to the SMS Transport Layer, which then encapsulates these messages into Transport Layer messages.

Six different message types are currently defined for the Teleservice Layer to support SMS. Table 1 lists these six message types, which have Message_Type values of “0001” through “0110”, and their short description. The message with Message_Type value of “0111” is new and described below.

TABLE 1

| Message_{—} | | |
|---|---|---|
| Type | Message Name | Description |
| “0000” | Reserved | |
| “0001” | SMS Deliver Message | used to send an SMS message to the |
| | | mobile station (mobile-terminated |
| | | only) |
| “0010” | SMS Submit Message | used to send an SMS message from |
| | | the mobile station (mobile-originated |
| | | only) |
| “0011” | SMS Cancellation | used by the mobile station to cancel |
| | Message | delivery of a pending SMS message |
| | | (mobile-originated only) |
| “0100” | SMS Delivery | used to send an acknowledgement of |
| | Acknowledgment | an SMS message having been re- |
| | Message | ceived by the mobile station (mobile- |
| | | terminated only) |
| “0101” | SMS User | used to send a manual acknowledge- |
| | Acknowledgment | ment from the user for an SMS |
| | Message | message (either direction) |
| “0110” | SMS Read | used to send an acknowledgement of |
| | Acknowledgment | an SMS message having been opened |
| | Message | by the user (either direction) |
| “0111” | SMS Memory | used to notify the network that the |
| | Available | SMS memory at the mobile station is |
| | Notification Message | available (mobile-originated only) |
| | All other values are | |
| | reserved | |

In Table 1, the Teleservice Layer messages that can only be sent by the mobile station are referred to as “mobile-originated only” messages, the messages that can only be sent by the network are referred to as “mobile-terminated only” messages, and the messages that may be sent by both the mobile station and the network are referred to as “either direction” messages.

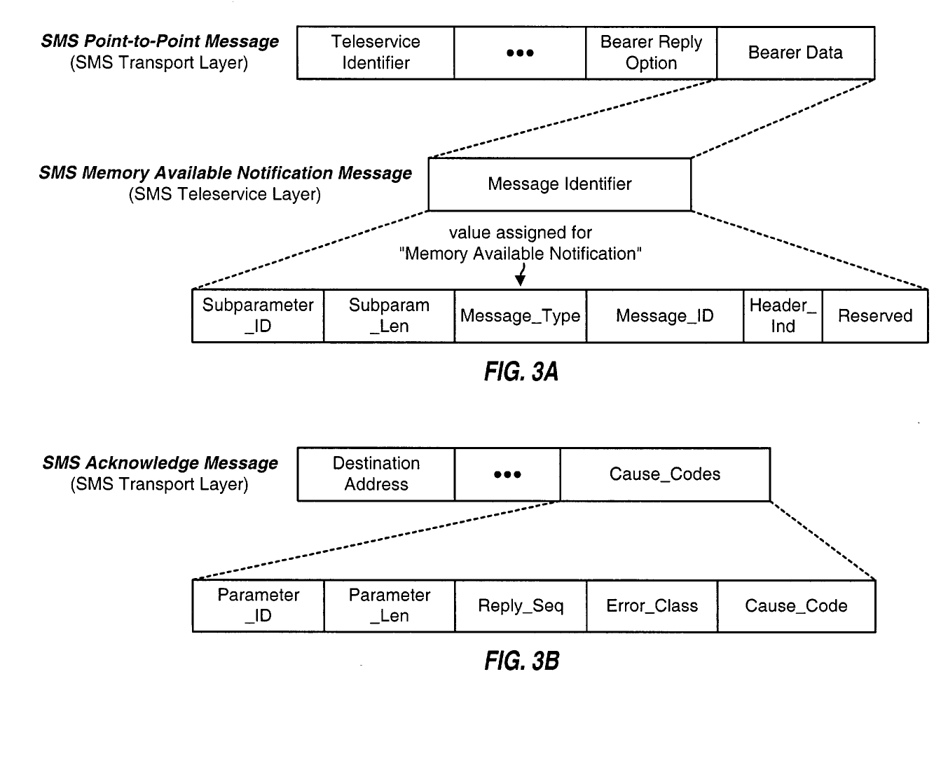

FIG. 3A is a diagram illustrating an embodiment of an SMS Memory Available Notification Message, which may be used to notify the network that the SMS memory at the mobile station is available. In an embodiment, the SMS Memory Available Notification Message is a Teleservice Layer message defined to have the format shown in FIG. 3A, which includes one mandatory subparameter: Message Identifier. This message may also be defined to include other optional subparameters that may be used to carry other information. For example, it might be useful to send the size of the available memory at the mobile station in the notification message.

Table 2 lists the fields in the Message Identifier subparameter, their lengths, and their short description and values (where appropriate).

TABLE 2

| | Length | |
|---|---|---|
| Field | (bits) | Description |
| Subparameter_ID | 8 | set to “00000000” for the Message Identifier |
| | | subparameter |
| Subparam_Len | 8 | set to “00000011”, which is the length (in |
| | | bytes) of the Message Identifier subpara- |
| | | meter, not including the Subparameter_ID |
| | | and Subparam_Len fields |
| Message_Type | 4 | set to a value assigned for the “Memory |
| | | Available |
| | | Notification” (e.g., “0111”) |
| Message_ID | 16 | set to a value used to identify the SMS |
| | | message |
| Header_Ind | 1 | Set to “0” for the SMS Memory Available |
| | | Notification Message |
| Reserved | 3 | set to “000” |

As also shown in FIG. 3A, the SMS Memory Available Notification Message is encapsulated within a Bearer Data parameter of an SMS Point-to-Point Message, which is a Transport Layer message. The SMS Point-to-Point Message further includes (1) a Teleservice Identifier parameter that identifies which upper layer service access point is sending or should receive the message, (2) a Bearer Reply Option parameter that is used to request a reply of an SMS Acknowledge Message from the receiver, and (3) other parameters. Although the Bearer Reply Option parameter in the SMS Point-to-Point Message is optional when used to carry other types of short message, this parameter may be made mandatory when the SMS Point-to-Point Message is used to carry the SMS Memory Available Notification Message.

A message center may need to support SMS for a number of mobile stations, some of which may have the capability to send the SMS Memory Available Notification Message while others may not have this capability. For the mobile stations without the notification capability, the message center can resend SMS messages using conventional techniques (e.g., resend after a timeout period). For the mobile stations with the notification capability, the message center may resend SMS messages only after it receives the memory available notifications from these mobile stations.

In an embodiment, a Notification Supported indicator is maintained for each mobile station and used to indicate whether or not the mobile station has the capability to notify the network when its memory becomes available. For each mobile station, this indicator may be set to “1” if the mobile station has the notification capability and cleared to “0” otherwise. If the message center has messages to resend to a given mobile station, it checks the Notification Supported indicator for the mobile station and applies the appropriate retransmission mechanism (i.e., either wait for the timeout period to expire or the receipt of the notification). Referring back to FIG. 2, the Notification Supported indicators for the mobile stations may be stored in memory 222. These indicators may be set or cleared based on information provided by the network operator, the mobile stations, or some other sources.

In an embodiment, the mobile station informs the network if it has the capability to send the memory available notification. This information may be sent in the SMS Acknowledge Message.

FIG. 3B is a diagram illustrating the SMS Acknowledge Message, which is a Transport Layer message. The SMS Acknowledge Message includes (1) a Destination Address parameter that identifies an address for the message, (2) a Cause_Codes parameter that is used to send an indication of whether or not an error has occurred and, if so, the type of error, and (3) possibly other parameters.

The Cause_Codes parameter further includes a number of subparameters, two of which are Error_Class and Cause_Code. The Error_Class subparameter may be set to “00” to indicate no error, “10” to indicate an error caused by a temporary condition, or “11” to indicate an error caused by a permanent condition. The Cause_Code parameter may be set to any one of the values defined in section 6.5.2.125 of the ANSI-41 standard document. A new error code may be defined for “Destination Resource Shortage with Notification”. This new error code may be assigned any one of the reserved or not yet assigned error code (or cause code) values. As a specific example, the new error code may be assigned a value of “40”.

The use of the new error code for “Destination Resource Shortage with Notification” allows the message center to easily determine whether or not a given mobile station supports memory available notification. If the message center receives an SMS Acknowledge Message with the new error code, then it can set the Notification Supported indicator for that mobile station.

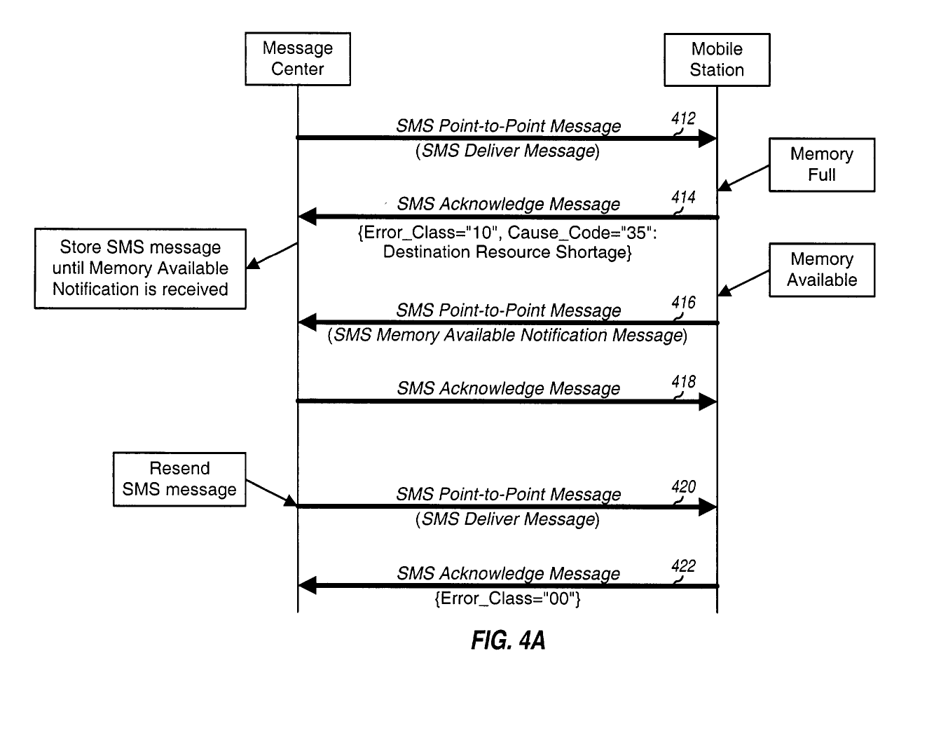

FIG. 4A is a diagram illustrating the signal flow for sending an SMS message from a message center to a recipient mobile station. FIG. 4A also shows the use of the SMS Memory Available Notification Message to facilitate SMS message transmission when the memory full condition is encountered at the mobile station. In FIG. 4A, Teleservice Layer messages are shown within parenthesis, and Transport Layer messages are shown without parenthesis.

Initially, the message center sends an SMS message to the mobile station via a (Teleservice Layer) SMS Deliver Message that is encapsulated within a (Transport Layer) SMS Point-to-Point Message that includes the Bearer Reply Option parameter (transaction 412). The mobile station receives this SMS message but its memory is full. Because the Bearer Reply Option parameter is included in the received message, the mobile station sends an SMS Acknowledge Message that includes an error code of “Destination Resource Shortage” (transaction 414). The message center receives this acknowledgment and, in response, stores the SMS message until a Memory Available Notification is received.

When the memory becomes available at the mobile station, it sends an SMS Memory Available Notification Message that is encapsulated within an SMS Point-to-Point Message that includes the Bearer Reply Option parameter (transaction 416). The message center receives this message and replies with an SMS Acknowledge Message (transaction 418). Thereafter, the message center can resend the SMS message to the mobile station via another SMS Deliver Message that is encapsulated within an SMS Point-to-Point Message (transaction 420). The mobile station receives this message and can send an SMS Acknowledge Message that includes an indication of success (transaction 422).

In another aspect, techniques are provided for the mobile station to keep track of whether or not it needs to send/resend the memory available notification to the network. The state of the SMS memory at the mobile station may continually change over time, from full to available and vice versa, as new SMS messages are received and old messages are deleted. If the memory becomes available and new SMS messages can be received, then the mobile station can send the SMS Memory Available Notification Message to inform the network of this condition. However, this memory available notification may not be successfully received by the network, and the mobile station may even be powered down before it can successfully notify the network. In that case, a mechanism is provided herein to inform the mobile station that it needs to resend the memory available notification when it is powered up.

FIG. 4B is a diagram illustrating the signal flow for sending an SMS message from the message center to the recipient mobile station with the use of the new error code “Destination Resource Shortage with Notification”. The signal flow for FIG. 4B is similar to the signal flow for FIG. 4A, except that the mobile station sends an SMS Acknowledge Message that includes an error code of “Destination Resource Shortage with Notification” (transaction 415) if it receives an SMS message but its memory is full, assuming that it supports this notification capability. The message center receives the new error code and can set the Notification Supported indicator for this mobile station.

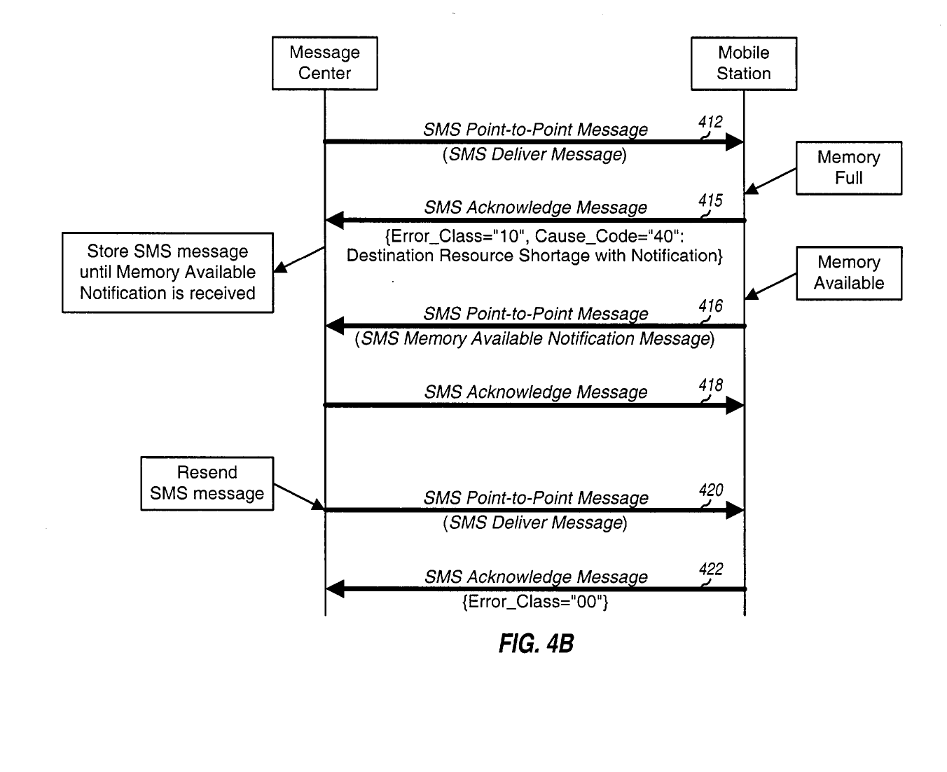

FIG. 5 shows an example state diagram 500 of the states for the SMS memory at the mobile station. In a Normal Operating state 510, new SMS messages may be received and processed in the normal manner since the SMS memory is not full. If a new SMS message is received and the memory is full, then the mobile station transitions to a Memory Full state 512. The mobile station remains in this state until the memory becomes available, at which time it transitions to a Memory Available state 514 and sends the SMS Memory Available Notification Message to the network. The mobile station remains in state 514 until the SMS Memory Available Notification Message is successfully received by the network. The mobile station would then transition to the Normal Operating state.

In an embodiment, a Notification flag is maintained by the mobile station and used to keep track of whether or not it needs to send/resend the SMS Memory Available Notification Message. In an embodiment, the Notification flag is set to “1” upon entering Memory Available state 514. If the Notification flag is set, then the mobile station would periodically and/or at designated times (e.g., at power up) resend the SMS Memory Available Notification Message. Upon receiving an indication that this notification message has been successfully received by the network, the Notification flag is cleared to “0”.

At the message center, a corresponding mechanism may be used to keep track of memory availability at each mobile station to be sent SMS messages. A Memory Available indicator may be maintained for each mobile station, and this indicator may be cleared to “0” whenever the SMS Acknowledge Message with an error code of “Destination Resource Shortage” or “Destination Resource Shortage with Notification” is received from the mobile station. This indicator is thereafter set to “1” when the SMS Memory Available Notification Message is received from the mobile station. Prior to sending an SMS message for a given mobile station, the Memory Available indicator for that mobile station may be checked, and the message would only be sent if the indicator is set.

Referring back to FIG. 2, the Notification flag may be maintained in memory 262 at the mobile station. This flag should be stored in a non-volatile memory since this information is intended to be retained even if the mobile station is powered down, so that the SMS Memory Available Notification Message may be resent if necessary when the mobile station is powered up. The Memory Available indicators for the mobile stations may similarly be maintained in a non-volatile memory (e.g., memory 222) at the message center. The non-volatile memory may be a Flash, an electrically erasable programmable read only memory (EEPROM), a multimedia card (MMC), or some other non-volatile memory type.

A mobile station may be designed with a removable user identity module (R-UIM). The R-UIM is used to store a subscriber's identity, which may include personal information such as network settings, privileges, preferences, phone books, and so on. The R-UIM makes it easier to roam to countries using different frequencies, or across CDMA or GSM networks, by allowing subscribers to exchange handsets while using the same removable module to maintain their personal information.

The R-UIM includes a number of elementary files (EFs) that are used to store various types of information related to SMS. For example, an EF_{SMSS} (SMS status) stores status information for SMS, which includes an “SMS Memory Capacity Exceeded Notification” flag. This flag indicates whether or not there is memory capacity available to store SMS messages. If an R-UIM is used in a mobile station, then this flag in the EF_{SMSS} may be used for managing the memory full condition. In particular, the Notification flag may be implemented with the “SMS Memory Capacity Exceeded Notification” flag in the R-UIM. The R-UIM is described in detail in TIA/EIA/IS-820, entitled “Removable User Identity Module (R-UIM) for TIA/EIA Spread Spectrum Standards,” TIA/EIA/IS-820-1, entitled “Removable User Identity Module (R-UIM) for TIA/EIA Spread Spectrum Standards, Addendum 1,” and 3GPP2 C.S0023-0, entitled “Removable User Identity Module (R-UIM) for cdma2000 Spread Spectrum Systems,” both of which are publicly available and incorporated herein by reference.

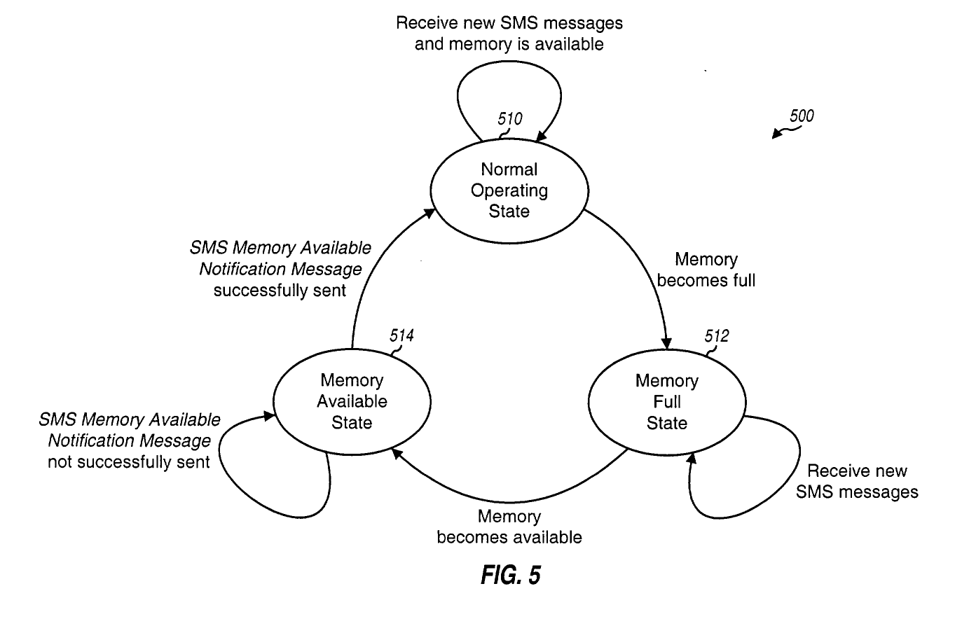

FIG. 6 is a flow diagram of an embodiment of a process 600 performed by the mobile station to process a mobile-terminated SMS message. This process integrates the management of the memory full condition and may be performed for each mobile-terminated SMS message.

Initially, an SMS message is received (step 612). A determination is then made whether or not the SMS memory is full (step 614). If the answer is no, then the received SMS message is processed in the normal manner and may be stored in the memory (step 622). A reply message (i.e., an SMS Acknowledge Message in CDMA-SMS) with an indication of success may be sent for this received SMS message if it includes a reply option (step 624). The process then terminates.

However, if the memory is determined to be full at step 614, then the received SMS message is discarded (step 632). A reply message with an error code of “Memory Full” or some other failure condition (i.e., an SMS Acknowledge Message with an error code of “Destination Resource Shortage” or “Destination Resource Shortage with Notification” in CDMA-SMS) may be sent for this received SMS message if it includes a reply option (step 634). A memory monitoring and notification process is then initiated if it has not already been initiated by a prior received SMS message (step 636). The process then terminates.

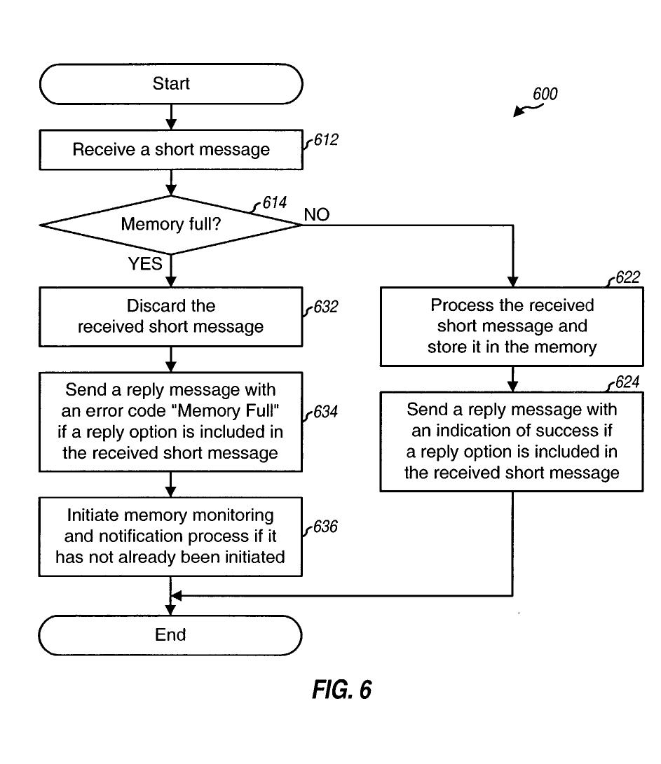

FIG. 7 is a flow diagram of an embodiment of process 636a performed by the mobile station to monitor its SMS memory and to send the memory available notification to the network. Process 636a may be used for step 636 in FIG. 6 and is initiated if the memory becomes full and the network has been informed of the memory full condition.

The memory full condition at the mobile station may occur for any number of reasons. For example, the memory may become full if too many SMS messages are stored in the memory, if the memory that may be used for SMS messages is instead used for some other functions, and so on. Moreover, the memory full condition may last for an unknown period of time until some memory is freed up, for example, by the user deleting some old SMS messages. The process thus waits until an indication is received that the memory has become available again (step 712).

Upon receiving this memory available indication in step 712, the Notification flag at the mobile station is set (step 714), and an SMS Memory Available Notification Message is sent to inform the network (step 716). A determination is then made whether or not this message has been successfully received by the network (step 720). As described above, the SMS Memory Available Notification Message can be sent with the Bearer Reply Option parameter, and the network would then send an acknowledgment if it correctly receives this message.

If it is determined that the SMS Memory Available Notification Message has been successfully received, then the Notification flag is cleared (step 730). The process then terminates. Otherwise, the process waits until an indication is received to resend the message (step 722). This resend indication may be received periodically and/or at designated times. Upon receiving the resend indication, a determination is made whether or not the memory has become full (step 724). Since the memory available for use for SMS may continually change over time, the memory is checked to make sure that it is still available prior to resending the SMS Memory Available Notification Message (step 726). If it is determined in step 724 that the memory is full, then Notification flag is cleared (step 728) and the process then returns to step 712 to wait for an indication that the memory has become available prior to sending the SMS Memory Available Notification Message.

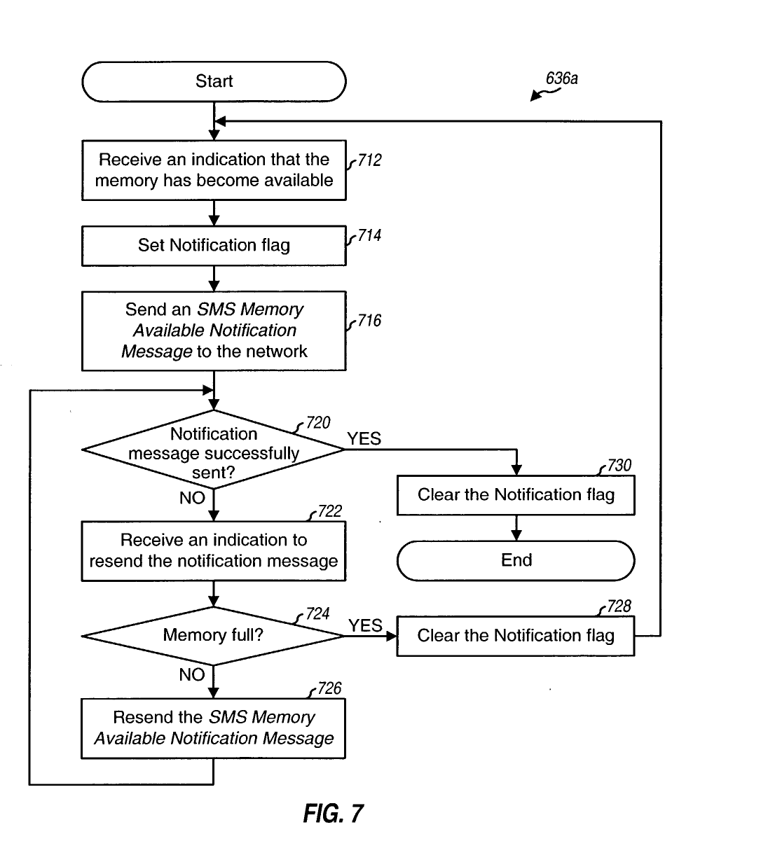

FIG. 8 is a flow diagram of an embodiment of a process 800 performed by the message center to send an SMS message to the mobile station. Whenever there is an SMS message to be sent to the mobile station, as determined in step 812, the Memory Available indicator for the mobile station is checked in step 814 to see whether or not this SMS message may be sent at this time. If the Memory Available indicator is not set, which denotes that the memory at the mobile station is full, then the SMS message is stored in the buffer (step 816), and the process thereafter returns to step 814. Otherwise, if the Memory Available indicator is set, then the SMS message is sent in the normal manner (step 818).

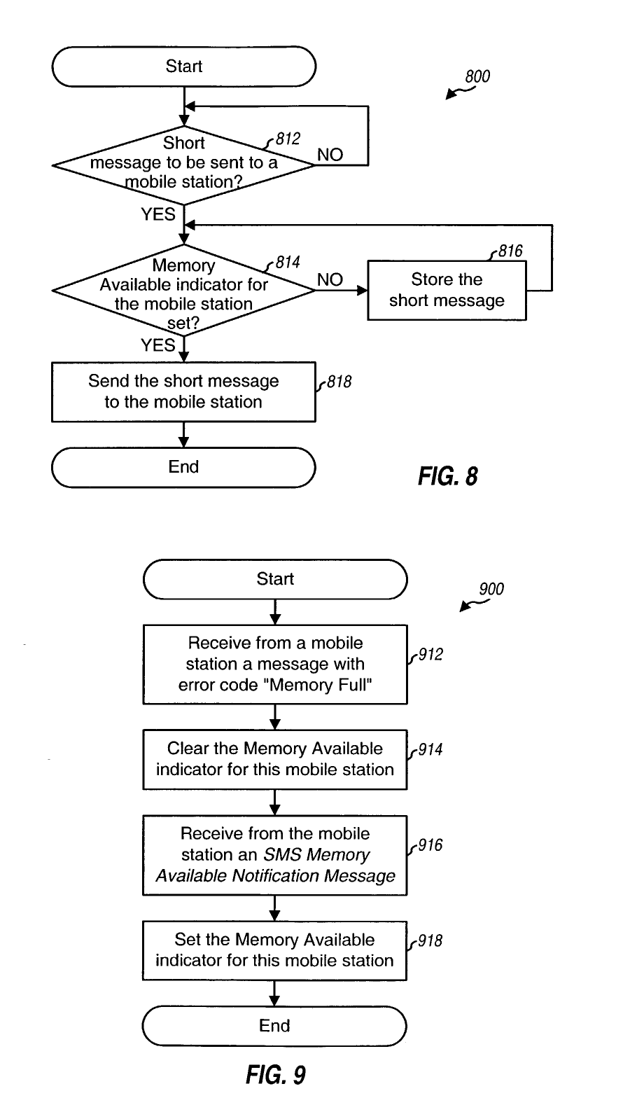

FIG. 9 is a flow diagram of an embodiment of a process 900 performed by the message center to maintain the Memory Available indicators for the mobile stations. Initially, a message with an error code of “Memory Full” (i.e., an SMS Acknowledge Message with an error code of “Destination Resource Shortage” or “Destination Resource Shortage with Notification” in CDMA-SMS) is received from a particular mobile station (step 912). The Memory Available indicator for this mobile station is then cleared to indicate that its memory is full and that SMS messages should not be sent to the mobile station (step 914). Thereafter, if an SMS Memory Available Notification Message is received from this mobile station (step 916), then the Memory Available indicator for the mobile station is set to indicate that its memory is not full and that SMS messages may be sent to the mobile station (step 918).

In the above description, an SMS Acknowledge Message with an error code of “Destination Resource Shortage with Notification” is sent by the mobile station in response to receiving an SMS message that includes the Bearer Reply Option parameter. In another embodiment, the mobile station can originate an SMS message to inform the message center whenever its memory becomes full, without having to receive a mobile-terminated SMS message, so that the message center does not attempt to send any SMS messages to the mobile station. In yet another embodiment, the mobile station can originate an SMS message to inform the network that its memory is available. If the same message is used for the notification of both the memory full and memory available conditions, then a new parameter may be defined and included in message. This new parameter may be set to “Available” to indicate that the mobile station's memory is available or “Exceeded” to indicate that the memory is full. In yet another embodiment, the mobile station can originate a notification message if its memory becomes full and if there is a likelihood of it receiving SMS messages from the network. This embodiment may be used to limit the number of transmissions for SMS message for the memory full notification.

The techniques described herein for managing the memory full condition may also be used for other destination resources that are needed to process received short messages. These resources may relate to hardware (e.g., memory, controller, or some other hardware element), codes (e.g., codes needed to retrieve the content of compressed, scrambled, and encrypted short messages), and so on. These techniques may also be used for mobile-terminated and mobile-originated short messages.

The techniques described herein for managing the memory full condition at the mobile station may be implemented by various means. For example, these techniques may be implemented in hardware, software, or a combination thereof. For a hardware implementation, the elements used to implement any one or a combination of the techniques described herein (e.g., the processes shown in FIGS. 6 through 9) may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

For a software implementation, the techniques for managing the memory full condition may be implemented with modules (e.g., procedures, functions, and so on) that perform the functions described herein. The software codes may be stored in a memory unit (e.g., memory units 222 and 262 in FIG. 2) and executed by a processor (e.g., controllers 220 and 260). The memory unit may be implemented within the processor or external to the processor, in which case it can be communicatively coupled to the processor via various means as is known in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for facilitating transmission of short messages in a wireless communication network, comprising:
receiving a short message;
sending a reply message with an indication of resource shortage if resources are not available to process the received short message; and
sending a notification message after the resources become available.

2. The method of claim 1, wherein the resources relate to a memory used to store short messages, and wherein the reply message is sent if the memory is full and the notification message is sent after the memory becomes available.

3. The method of claim 1, further comprising:
resending the notification message if a prior notification message was not successfully received.

4. The method of claim 3, wherein the notification message is periodically resent until it is successfully received.

5. The method of claim 3, wherein the notification message is resent during power-up of a mobile station.

6. The method of claim 3, further comprising:
receiving an acknowledgment that the notification message has been successfully received; and
terminating subsequent retransmissions of the notification message.

7. The method of claim 1, further comprising:
maintaining a flag indicative of whether or not the notification message needs to be resent.

8. The method of claim 7, wherein the flag is maintained in a non-volatile memory.

9. The method of claim 1, wherein the reply message includes an indication that a notification message will be sent if the resources become available.

10. The method of claim 1, wherein the wireless communication network is a cdma2000 network.

11. The method of claim 1, wherein the wireless communication network is an IS-95 network.

12. A method for sending short messages in a wireless communication network, comprising
receiving from a mobile station a message with an indication of resource shortage at the mobile station;
halting transmission of short messages to the mobile station;
receiving from the mobile station a notification message that the resources have become available; and
enabling transmission of short messages to the mobile station.

13. The method of claim 12, wherein the resources relate to a memory used to store short messages at the mobile station, and wherein the notification message is sent by the mobile station after the memory becomes available.

14. The method of claim 12, wherein the message received from the mobile station further includes an indication that the notification message will be sent if the resources become available.

15. The method of claim 12, further comprising:
maintaining an indicator to keep track of availability of the resources at the mobile station.

16. The method of claim 15, wherein the indicator is checked prior to sending short messages to the mobile station.

17. A memory communicatively coupled to a digital signal processing device (DSPD) capable of interpreting digital information to:
receive an indication of a short message having been received from a sender in a wireless communication network;
direct transmission of a reply message with an indication of resource shortage if resources are not available to process the received short message; and
direct transmission of a notification message after the resources become available.

18. An apparatus in a wireless communication network and operable to facilitate transmission of short messages, comprising:
means for receiving a short message from a sender in the wireless communication network;
means for sending a reply message with an indication of resource shortage if resources are not available to process the received short message; and
means for sending a notification message after the resources become available.

19. The apparatus of claim 18, wherein the resources relate to a memory used to store short messages, and wherein the notification message is sent after the memory becomes available.

20. The apparatus of claim 18, further comprising:
means for resending the notification message periodically or at designated times until the notification message is successfully received by the sender.

21. The apparatus of claim 18, further comprising:
means for maintaining a flag indicative of whether or not the notification message needs to be resent.

22. An apparatus in a wireless communication network and operable to send short messages, comprising:
means for receiving from a mobile station a message indicating resource shortage at the mobile station;
means for halting transmission of short messages to the mobile station;
means for receiving from the mobile station a notification message that the resources have become available; and
means for enabling transmission of short messages to the mobile station.

23. The apparatus of claim 22, wherein the resources relate to a memory used to store short messages, and wherein the notification message is received from the mobile station after the memory becomes available.
